(19) United States
(12) Patent Application Publication
(10) Pub. No.: US 2025/0154432 A1
(43) Pub. Date: May 15, 2025

(54) WASHING/WAXING CONCENTRATE, METHOD OF MAKING, AND METHOD OF USE

(71) Applicant: 3M INNOVATIVE PROPERTIES COMPANY, St. Paul, MN (US)

(72) Inventor: DERRICK TARN, Santa Ana, CA (US)

(21) Appl. No.: 18/861,919

(22) PCT Filed: May 2, 2023
(86) PCT No.: PCT/IB2023/054571

§ 371 Date: Oct. 31, 2024

Related U.S. Application Data
(60) Provisional application No. 63/345,995, filed on May 26, 2022.

(51) Int. Cl. C11D 1/14; C11D 1/75; C11D 1/94; C11D 3/00; C11D 3/37

(52) U.S. Cl. CPC C11D 1/14; C11D 1/75; C11D 1/94; C11D 3/0047; C11D 3/373; C11D 3/3757; C11D 3/3776; C11D 2111/14; C11D 2111/40

(57) ABSTRACT

A washing/waxing concentrate, a waxing/washing composition obtainable by diluting the concentrate, and methods of concurrently washing and waxing a surface using the washing/waxing composition. The washing/waxing concentrate and composition comprises a first, aqueous washing phase and a second, hydrophobic waxing phase. The second, hydrophobic waxing phase comprises a hydrophobic, film-forming material that is present in the form of droplets that are stabilized by an electrostatic complex coacervate formulated using anionic polymer along with cationic polymer. The washing/waxing concentrate and composition further comprises a surfactant package comprising an anionic surfactant.

### BACKGROUND

Surfaces of e.g. motor vehicles and the like are frequently washed and/or waxed in order to remove dirt, grime and so on, and to impart a glossy appearance to the surface.

### SUMMARY

In broad summary, herein is disclosed a washing/waxing concentrate, a waxing/washing composition obtainable by diluting the concentrate, and methods of concurrently washing and waxing a surface using the washing/waxing composition. The washing/waxing concentrate and composition comprise a first, aqueous washing phase and a second, hydrophobic waxing phase. The second, hydrophobic waxing phase comprises a hydrophobic, film-forming material that is present in the form of droplets that are stabilized by an electrostatic complex coacervate. The washing/waxing concentrate and composition further comprise a surfactant package. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a side perspective view of an exemplary arrangement depicting a washing implement being dipped into a container that holds a washing/waxing composition.

FIG. 2 is a Working Example photograph of a bucket containing a sudsed washing/waxing composition, with a washing implement dropped into the bucket.

FIG. 3 is a Working Example photograph of an automotive test panel after having been sprayed with water, prior to being subjected to a concurrent washing/waxing treatment as disclosed herein.

FIG. 4 is a Working Example photograph of the test panel of FIG. 3 being concurrently washed and waxed with the washing implement and washing/waxing composition of FIG. 2.

FIG. 5 is a Working Example photograph of the test panel being spray-rinsed with water immediately after being concurrently washed and waxed.

FIG. 6 is a Working Example photograph of the test panel immediately after being spray-rinsed.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings are not to scale and are chosen for the purpose of illustrating different embodiments of the invention. In particular the dimensions of the various components are depicted in illustrative terms only, and no relationship between the dimensions of the various components should be inferred from the drawings, unless so indicated.

### DETAILED DESCRIPTION

The term “configured to” and like terms is at least as restrictive as the term “adapted to”, and requires actual design intention to perform the specified function rather than mere capability of performing such a function. Terms such as “a” and “an”, when used in combination with “comprises”, “comprising”, and like terms, will be understood to mean “at least one”; e.g. the phrase “comprises a surfactant” means “comprises at least one surfactant”. Terms such as “waxing”, “waxed”, and the like, are used in accordance with their colloquial use denoting a process of forming of a hydrophobic protective film on the surface of an entity (e.g., a motor vehicle). Such terminology does not require that the hydrophobic film must necessarily include a wax (e.g., carnauba wax) according to chemical composition. Rather, a hydrophobic film formed by “waxing” may for comprise, or consist of, silicone materials for example. The term “hard” surface denotes a surface such as of a motor vehicle and other generally similar surfaces, as discussed in detail herein. The term “hard” surface specifically excludes fibrous materials such as e.g. textiles and clothing, and biological materials such as e.g. human skin and hair, and foodstuffs. The term “water” (e.g. as used in phrases such as “diluted in water”) is used in general and does not preclude the presence of small amounts of other ingredients (e.g. salts, minerals, chlorination residues, and so on), unless otherwise noted.

### Concurrent Washing/Waxing

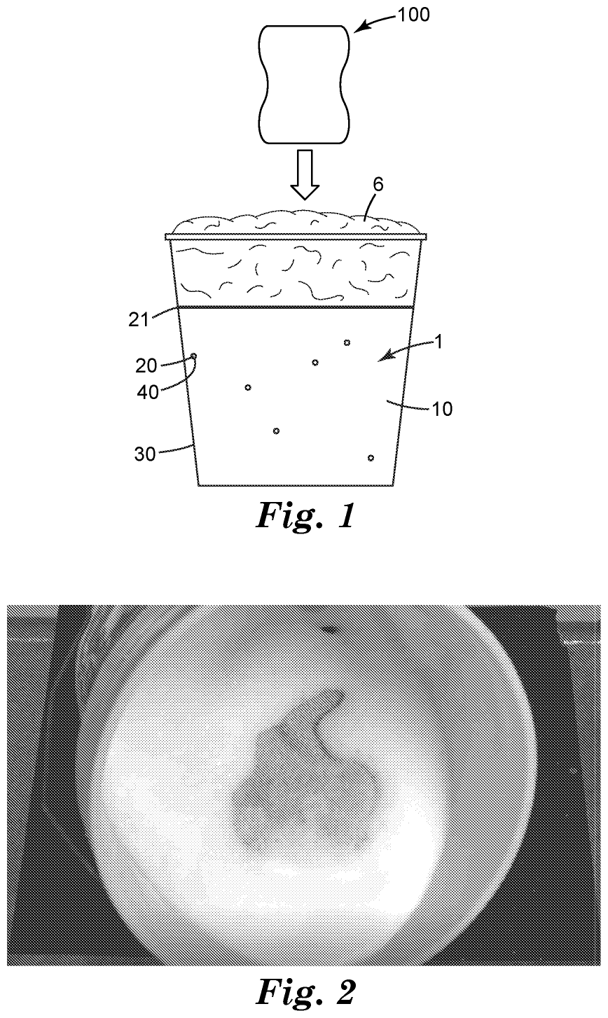

Disclosed herein is a method of concurrently washing and waxing a hard surface, e.g., of a vehicle such as an automobile. With reference to FIG. 1, the method comprises disposing a washing/waxing composition 1 onto and into a washing implement 100 (e.g. by dipping the washing implement into a container 30 holding the washing/waxing composition), then contacting the washing implement with the hard surface and moving the washing implement about the hard surface. The moving about of the washing implement on the surface will distribute the washing/waxing composition onto the surface to perform concurrent washing and waxing as discussed below. After the concurrent washing/waxing operation is performed, the surface may be rinsed with water, e.g. by a water spray.

Washing/waxing composition 1 is a water-based composition, by which is meant that composition 1 comprises at least 75 wt. % water. Washing/waxing composition 1 comprises a first, aqueous washing phase 10 and a second, hydrophobic waxing phase 20 that is different from the first, aqueous washing phase. In many embodiments, the first, aqueous washing phase 10 will be present as a continuous phase, and the second, hydrophobic waxing phase 20 will be present as discontinuous phase, e.g. in the form of droplets that are dispersed in the first, aqueous washing phase 10. Moving the washing implement 100 about the surface causes both the first, aqueous washing phase 10 and the second, hydrophobic waxing phase 20 to be brought into contact with the surface. This enables cleaning (washing) of the surface (e.g., the removal of dirt, debris, grime, and so on therefrom) and concurrent waxing of the surface, meaning deposition of material on the surface that forms a hydrophobic, protective film on the surface. The second, hydrophobic waxing phase 20 thus comprises a hydrophobic, film-forming material; the droplets of the second, hydrophobic waxing phase 20 are stabilized by a complex electrostatic coacervate 40 as discussed in detail later herein. The washing/waxing composition 1 also comprises a surfactant package to at least facilitate the washing function of the composition, also as discussed in detail later herein.

The arrangements disclosed herein allow washing and waxing operations to be performed concurrently. By this is meant that the washing and waxing operations do not have to be, and are not, performed in a sequential manner in which a surface is washed with a first, washing composition after which a separate, second, waxing composition is used to perform the waxing. In other words, a concurrent washing/waxing procedure as described herein differs from customary approaches in which separate, sequential washing and waxing operations are performed using separate washing and waxing compositions. In particular, the herein-disclosed arrangements do not require a drying period between washing and waxing operations. These arrangements also do not require any additional step such as a drying or buffing step after the concurrent washing/waxing (and water-rinsing) is performed, although such a step may be performed if desired.

The arrangements disclosed herein enable a “one-bucket” mode of operation in which washing and waxing are performed using a single, common container 30 that contains the washing/waxing composition 1 and into which a washing implement 100 can be inserted to imbibe the washing/waxing composition, after which the washing implement is contacted with a surface to perform both washing and waxing.

Those of ordinary skill in the preparation and use of washing and waxing compositions will appreciate that the art is replete with instances in which it is asserted that “simultaneous” washing and waxing of surfaces can be performed. However, the performance of simultaneous washing and waxing has been limited by the fact that these operations are essentially working at cross purposes. That is, the goal of a washing composition is to remove dirt, grime, grease and so on from a surface, with the washing composition having one or more surfactants for this purpose. The goal of a waxing composition is to deposit a layer of protective, hydrophobic film-forming material on the surface (e.g., so that the surface becomes glossy and so that water beads up and runs off the surface). These goals are essentially at odds. That is, in heretofore-proposed concurrent washing/waxing systems, a surfactant that is present for washing purposes may sequester a hydrophobic film-forming material (a “wax”) into surfactant-stabilized micelles thus preventing much of the film-forming material from being deposited onto the surface that is desired to be “waxed”. Conversely, the hydrophobic film-forming material may deplete much of the surfactant into forming such surfactant-stabilized micelles, so that less surfactant is available to interact with dirt on the surface to remove the dirt from the surface. In fact, the hydrophobic material may interfere with initial formation of foam and suds (e.g. upon “frothing” the washing/waxing composition). Since users often equate high suds formation with greater washing power, users may perceive low suds formation as an indication that the composition is deficient in washing power.

Thus, although some arrangements have been proposed in the art that claim to enable the performing of concurrent washing and waxing, typically each operation is not performed to the maximum extent possible. For example, such operations may not render a surface as clean, and/or as hydrophobic, as might be achieved by performing separate, sequential washing and waxing operations. The arrangements disclosed herein can allow washing and waxing operations to be performed concurrently (e.g., in a one-bucket mode of operation), while enabling either, or both, operations to be performed to a more complete extent than previously achieved. In particular, such arrangements may enhance the hydrophobicity of the washed/waxed surface in comparison that achieved by concurrent washing/waxing approaches in the art. In fact, it has been found that the herein-disclosed arrangements allow a concurrently washed/waxed surface to exhibit excellent hydrophobicity immediately upon performing the concurrent washing/waxing, without any additional step or procedure being required other than e.g. rinsing the washed/waxed surface.

Thus in summary, the present work has demonstrated that concurrent washing and waxing using the compositions and methods disclosed herein can allow an effective amount of a hydrophobic, film-forming material to be deposited onto a surface to enable a readily observable, long-lasting hydrophobic protective film to be formed thereon, as demonstrated in various Figures and as discussed in detail in the Working Examples. Moreover, the compositions and methods are configured so that the presence of the second, hydrophobic waxing phase does not unduly deplete the surfactant that is available in an active form to perform washing; for example, the herein-disclosed washing/waxing compositions exhibit abundant suds, again as demonstrated in the Figures and Working Examples.

As briefly summarized above, the arrangements disclosed herein rely on contacting a surface with a washing implement 100 that bears a washing/waxing composition 1 that includes a first, aqueous phase that is considered to be a “washing” phase, and that includes a second, hydrophobic phase that is considered to be a “waxing” phase. An exemplary way in which the arrangements disclosed herein may be implemented is depicted in generic representation in FIG. 1. FIG. 1 depicts a container 30 (e.g., a bucket, such as, e.g., a 2, 3, 4 or 5 gallon bucket, which is a convenient size for manual washing of a motor vehicle) comprising a washing/waxing composition 1. Washing/waxing composition 1 can be obtained by taking a herein-disclosed washing/waxing concentrate and diluting it in water as discussed in detail herein. The term “composition” is used herein to specifically refer to a composition as actually used to wash/wax a surface, as distinguished from a “concentrate” from which the composition is obtained via dilution (although the concentrate is of course a composition in the general sense).

Washing/waxing composition 1 includes a first, aqueous washing phase 10 and a second, hydrophobic waxing phase 20; the first, aqueous washing phase 10 will often be present as a continuous phase and the second, hydrophobic waxing phase 20 will often be present as discontinuous phase, e.g. in the form of droplets that are dispersed in the first, aqueous washing phase 10. A washing implement 100 may be inserted into the interior of container 30 so that it is at least partially, or completely, immersed in the washing/waxing composition 1, as indicated in FIG. 1. In doing so, at least some portions of the washing implement 100 will contact, and imbibe, the first, aqueous washing phase 10, and at least some portions will contact, and imbibe, the second, hydrophobic waxing phase 20.

Washing implement 100, having been inserted into and removed from container 30, will thus bear first, aqueous washing phase 10 and second, hydrophobic waxing phase 20, for application to a surface as the washing implement is moved about the surface. In some embodiments, this may be performed manually, by which is meant that the washing implement is held by a user's hand (or worn on a user's hand) and is dipped into the container and moved about the surface by hand, without the use of any motorized or automated equipment.

One convenient way in which the above arrangements can be achieved is by the diluting of a washing/waxing concentrate into water to form washing/waxing composition 1. That is, in many embodiments a washing/waxing product may be supplied in the form of a concentrate, which will take up less volume and shelf space, will weigh less, will achieve lower shipping costs, and so on, in comparison to a washing/waxing composition that is shipped and inventoried in its final, as-used condition. Thus, a washing/waxing composition 1 can be formed by disposing a washing/waxing concentrate into a container 30 along with a desired amount of water to dilute the washing/waxing concentrate to form the final, desired washing/waxing composition.

Such a process may be carried out in any manner and in any order; e.g., by adding the concentrate to the container and subsequently adding water, or vice versa. As will be well understood, such a process as carried out by a user often involves forcefully mixing the concentrate and the water. This may be done e.g. by (at least during the later stages of adding water to an aqueous mixture in which at least some of the concentrate is already present) spraying the water into the container as a high-velocity spray or stream that roils and froths the water to form a highly sudsed mixture. The present work has demonstrated that the diluting into water of a washing/waxing concentrate as disclosed herein can produce a washing/waxing composition that exhibits a large amount of suds 6 visible above the upper surface 21 of the liquid water, as indicated in exemplary manner in FIG. 1 and as evidenced in the Working Example photograph of FIG. 2.

### Coacervate

As noted, the second, hydrophobic waxing phase 20 (in both a washing/waxing concentrate, and in a washing/waxing composition obtained by diluting the concentrate into water) will be present as discontinuous phase, e.g. in the form of discrete droplets that are dispersed in a continuous, first aqueous washing phase 10. As disclosed herein, these droplets of the second, hydrophobic waxing phase 20 are stabilized in the first, aqueous washing phase 10 by a complex electrostatic coacervate 40.

As used herein, the term “complex electrostatic coacervate” (occasionally shortened herein to “coacervate”) is defined in accordance with the generally accepted literature definition (see e.g. Recent Progress in the Science of Complex Coacervation; Sing and Perry; Soft Matter 16, 2885 (2020); and, Polyelectrolyte Complex Coacervation by Electrostatic Dipolar Interactions; Adhikari et al.; J. Chem. Phys. 149, 163308 (2018). Thus a coacervate is defined herein as a liquid-liquid phase-separated solution of oppositely charged polyelectrolyte chains that are present as a polyelectrolyte-rich phase (the “coacervate” phase) amidst a dilute (polyelectrolyte-poor) aqueous phase. (The combination of the coacervate phase and the dilute, aqueous phase will be referred to herein as a coacervate system.) Such coacervates are based on the spontaneous formation of polycation-polyanion complexes due to electrostatic attraction under appropriate conditions as discussed herein, with the coacervate phase typically being present as discrete parcels (e.g. clusters of polyelectrolytes) amidst a continuous aqueous phase.

Coacervates as disclosed herein may be formulated using an anionic polyelectrolyte (e.g. acrylic acid based, water-soluble anionic polymers) along with a cationic polyelectrolyte (e.g. polyquarternium based, water-soluble cationic polymers). While a coacervate may be formed via any method that can successfully meet the objectives outlined herein, one convenient preparation method is to dissolve one of the charged polymers (e.g. the anionic polymer) in aqueous solution, and then to introduce the other, oppositely-charged polymer (e.g. the cationic polymer) into the solution. With appropriate choice of the polymers and conditions of introduction, the polymers will spontaneously form a coacervate, e.g. as evidenced by the formerly-clear solution turning turbid. It is believed that the coacervate complexes (i.e. clusters of oppositely-charged polymer chains) may be mainly present as extremely small structures, e.g. smaller than the size of hydrophobic waxing phase droplets that are stabilized by the coacervates, as discussed below.

As disclosed herein, a coacervate 40 can be used to stabilize a second, hydrophobic waxing phase 20 as a discontinuous phase, e.g. in the form of droplets that are dispersed in a first, aqueous washing phase 10. The first, aqueous washing phase 10 will thus correspond to the above-described dilute (polyelectrolyte-poor) aqueous phase of the coacervate system. One exemplary manner in which this can be achieved is to introduce the second, hydrophobic waxing phase (e.g. as a liquid) into the coacervate-containing aqueous mixture with high shear (e.g. by vortexing) so as to disperse the second phase into discrete parcels (e.g. droplets) within the first, aqueous phase. It has been found that the already-present coacervate clusters can apparently preferentially gather around the discrete hydrophobic parcels in such a manner as to at least partially encapsulate the hydrophobic parcels. The exact structure that is formed is not known with certainty. Without wishing to be limited by theory or mechanism, it is postulated that some coacervate complexes, e.g. in the form of very small clusters, may group around at least portions of each hydrophobic droplet. Again, while the exact structure(s) that is formed is not known with certainly, experimental results have consistently verified that the presence of the coacervate phase can stabilize the hydrophobic droplets. That is, the hydrophobic droplets will remain in their small (estimated to be in the size range of approximately 10-100 microns, although this is not known with certainty), dispersed form rather than agglomerating to form a macroscopic phase-separated system. As discussed in the Working Examples, it has been found that representative washing/waxing concentrates, comprising coacervate-stabilized hydrophobic waxing phases in the form of small droplets, are quite stable, even to the extent of surviving long-term accelerated aging at high temperature.

It is further noted that (the Working Example coacervates being typically prepared in the form of concentrates that are then diluted into water to form a washing/waxing composition), the process of aggressively diluting the concentrate with a high-speed water spray (e.g. frothing) has not been found to disrupt the stabilization of the hydrophobic droplets by coacervates. That is, a frothing process does not seem to release or expel the hydrophobic waxing phase from its coacervate-stabilized droplets to an extent that might interfere with the ability to form robust suds in the frothed composition. Nor does the hydrophobic waxing phase display any tendency to agglomerate to form a macroscopically visible phase in the composition, or any tendency to form an emulsion with any surfactants present in the composition in a manner in a way that might interfere with the ability to deposit the hydrophobic waxing phase on surface.

Based on the above discussions it will be appreciated that a coacervate can stabilize a set of hydrophobic droplets (again, of a size range estimated to be microns) within a continuous aqueous medium, in somewhat similar manner as a surfactant can stabilize hydrophobic droplets by forming e.g. micelles. Thus in some overall aspects, a washing/waxing concentrate (and a washing/waxing composition obtained therefrom) as disclosed herein may bear some resemblance to a conventional macroemulsion. However, ordinary artisans will appreciate that a coacervate, being formed by the electrostatic interaction of anionic water-soluble polymers and cationic water-soluble polymers, is very different from an assembly that relies on surfactant molecules, which characteristically include a highly water-soluble segment (which may be charged or neutral) and a highly hydrophobic segment. The orienting of such surfactants with the hydrophobic segments inward and the hydrophilic segments outward to form a micelle, is a very different phenomenon from the electrostatically-driven interaction of cationic and anionic polyelectrolytes to form a coacervate.

In particular, it is postulated that a hydrophobic droplet as stabilized by a coacervate is not arranged in the manner of a hydrophobic droplet that is sequestered inside a surfactant micelle with the hydrophobic ends of the surfactant molecules interacting with the hydrophobic surface of the hydrophobic droplet. In the present case, the hydrophobic droplets are believed to not necessarily reside “inside” the above-described individual coacervate structures (clusters) formed by the interaction of positively-charged and negatively charged polymers. Rather, the coacervate structures are believed to be extremely small with the interaction between the coacervate clusters and the larger hydrophobic droplets being mainly in the form of the individual coacervate clusters collectively gathering around each hydrophobic droplet. (It is acknowledged that it is possible that in some instances, some of these individual coacervate clusters that are in proximity with the hydrophobic droplet, may coalesce or otherwise interact with each other; as noted herein, the exact structures and arrangements that are formed cannot be known with certainty.)

As to why the coacervate structures should gather so preferentially around the hydrophobic droplets in a manner that stabilizes the droplets, this similarly cannot be known with certainty. In fact, it seems unexpected that this should occur, since polyelectrolytes, being charged, would not be expected to be attracted to such a hydrophobic surface. Even though the charged coacervate structures would not necessarily be expected to interact strongly with hydrophobic droplets, it may be that, for example, at least partially surrounding the hydrophobic droplets with coacervates may be thermodynamically preferable over having the surfaces of the hydrophobic droplets completely exposed to water. (However, even this may not provide a full explanation since, as discussed later herein, the stabilization of hydrophobic droplets by coacervates can be achieved even when the system includes one or more surfactants.)

Thus, without resorting to undue speculation, it is merely affirmed that the stabilization of hydrophobic droplets by coacervates has been confirmed in a large number and variety of experiments as discussed herein; and, it is emphasized that ordinary artisans will consider a coacervate-stabilized hydrophobic phase as disclosed herein to be different from, and distinguished from, a hydrophobic phase that is in the form of e.g. surfactant-stabilized micelles. So, macroemulsions, microemulsions, and so on, of hydrophobic materials as conventionally stabilized by surfactants, cannot be equated with the herein-disclosed arrangements.

Whatever the specific mechanism of interaction between the coacervate structures and the hydrophobic droplets, it is postulated that the delivering of a second, hydrophobic phase onto a surface e.g. for purposes of “waxing” the surface, that does not necessarily entail having to “break” any individual coacervate clusters in the manner that individual surfactant-stabilized micelles may need to be broken (ruptured) in order to release a hydrophobic material from within the micelles. That is, in the present case, it seems that coacervates do not necessarily have to be broken in terms of the individual coacervate clusters being disrupted. Rather, the hydrophobic material merely needs to be able to escape from the assemblage of coacervate clusters regardless of whether or not any of the coacervate clusters are individually disrupted or otherwise broken. For example, it may be that the mechanical shearing action of moving a washing implement 100 about a surface is adequate to liberate the second, hydrophobic waxing phase from its coacervate-stabilized condition to a degree sufficient to allow the waxing phase to be deposited on the surface. In any event, experiments so far have indicated that it does not seem necessary to e.g. significantly change the physicochemical condition of the washing/waxing composition (whether in terms of temperature, pH, salt concentration, and so on) to “break” the coacervate, in order to perform the waxing.

While the term “droplet” is used often herein to denote individual, e.g. discrete entities of the second, hydrophobic phase, this term is used in a broad sense and does not, for example, require that the second phase be present in the form of purely spherical entities. The term droplet is thus used in a similar sense as the term “parcel”; such a parcel of hydrophobic material may be e.g. ellipsoid or cylindrical in shape, or in the form of bilayers. Indeed, while it is believed that most of the coacervate-stabilized “parcels” of the second, hydrophobic phase are in the form of discrete entities, it is possible that at least some of the coacervate-stabilized parcels may exhibit some degree of supramolecular assembly to form larger-scale aggregated structures. (Such structures are still expected to be quite small so as to not form a readily visible macroscopic second phase in a concentrate or in a composition.)

It is also noted that it is not necessarily required that the entirety of the second, hydrophobic phase must be present in a coacervate-stabilized form in order to achieve the objectives herein. All that is needed is that a useful percentage (e.g., greater than 70, 80, 90, or 95 wt. %) of the total hydrophobic phase is in a coacervate-stabilized state that allows it e.g. to be stored indefinitely but that also allows it to be easily transferrable onto a washing implement and from there to a surface to be washed/waxed (with the further caveat that any residual non-coacervate-stabilized hydrophobic phase should not have any unacceptable effects, e.g. it should not form a macroscopically visible second phase or interfere with suds formation). However, the present work has provided indications that the vast majority of the second, hydrophobic phase is in fact in a coacervate-stabilized form, even in concentrates with rather high levels (e.g. 5, 6, and even up to 10, wt. %) of the second, hydrophobic waxing phase.

### Anionic and Cationic Polymers

Coacervates are commonly formulated with a balanced proportion of cationic polyelectrolyte chains and anionic polyelectrolyte chains so that the majority of the polyelectrolyte chains reside in the coacervate (phase) and so that the continuous aqueous phase consequently contains few polyelectrolyte chains. However, in the present work it has been found that in at least some instances it can be advantageous to provide an excess of one of the polyelectrolytes (e.g. the anionic polyelectrolyte). Although the exact status of the excess anionic polymer chains is not known with certainly, it is postulated that at least some of them may reside in the continuous aqueous phase. Such arrangements have not detracted from the ability to form coacervates nor from the ability of the coacervates to stabilize the droplets of the second, hydrophobic waxing phase. And, in some instances the presence of excess anionic polymer that (presumably) is not present in the form of a coacervate seems to have advantageous effects. For example, in some instances the presence of excess anionic polymer seems to significantly enhance the viscosity of the overall concentrate (this is one factor that seems to indicate that the excess anionic polymers reside in the continuous aqueous phase, since they would not necessarily be expected to increase the overall system viscosity if they were to merely associate with the existing coacervate clusters.) This thickening effect can be a desirable attribute because users sometimes look with disfavor on a concentrate that seems watery or thin. In the present work, the presence of excess anionic polyelectrolyte has been found to provide a zeta potential that is negative, and of a fairly large magnitude, e.g. greater (in the sense of being farther from 0 mV) than −20, −25−30, or −35 mV. (Zeta potentials were obtained on illustrative samples that comprised aqueous formulations of the anionic and cationic polyelectrolytes, at appropriate dilution and in the absence of other ingredients, e.g. surfactants and a hydrophobic, waxing material.) In various embodiments a washing/waxing concentrate as disclosed herein may comprise at least 0.03, 0.10, 0.20, 0.30, or 0.40 wt. % anionic polymer (in the case of multiple anionic polymers, this will be the total of all such anionic polymers). In further embodiments, the one or more anionic polymers may be present at most at 1.0, 0.80, 0.60, or 0.50 wt. %. Here and elsewhere herein, such a wt. % will be the weight percent of the actual active ingredient in the washing/waxing concentrate (or in the washing/waxing composition), unless otherwise specified. Thus for example if an anionic polymer is provided as a raw material in the form of a solution or dispersion that contains 40% active ingredient (anionic polymer) and the raw material is added to the concentrate at 2.0 wt. %, the actual percent active of the anionic polymer in the concentrate will be 0.80%. It is also noted that some raw materials may be provided (e.g. at 20-40 percent active ingredients) e.g. in the form of a dispersion, emulsion, or the like. Such raw materials may themselves include some small amount of e.g. surfactant, emulsifier or the like; such raw materials may also include a small amount of other materials, whether e.g. antioxidants, biocides, and so on. Any such additives are expected to be present in the herein-disclosed washing/waxing concentrate (and particularly, in the final washing/waxing concentrate obtained from diluting the concentrate) at negligible quantities and will not be included in any calculations herein.

In various embodiments a washing/waxing concentrate as disclosed herein may comprise at least 0.02, 0.03, 0.04, 0.05, or 0.06, wt. % cationic polymer (in the case of multiple cationic polymers, this will be the total of all such cationic polymers). In further embodiments, the one or more cationic polymers may be present at most at 0.20, 0.15, 0.10, or 0.07 wt. %.

In various embodiments, the weight ratio of anionic polymer (again, in total) to cationic polymer (in total) in the washing/waxing concentrate (and thus in the resulting washing/waxing composition) may be approximately 1.0, or may be at least 1.05, 1.10, 1.5, 2.0, 4.0, 6.0, 8.0, or 10. In further embodiments, the weight ratio may be at most 20, 16, or 12. Thus in some embodiments, a weight ratio of anionic to cationic polymer may be extremely high, e.g. upwards of 10:1. Such arrangements have been found to work satisfactorily (in fact, very well) as evidenced by the Working Examples herein.

Any anionic polymer may be used, with the caveat that the anionic polymer should be sufficiently water soluble, and should possess sufficiently high charge density (under the conditions employed), to allow the objectives presented herein to be achieved. In some embodiments, an anionic polymer that is used to form a coacervate may be, or include, an acrylic acid based anionic polymer. (Here and elsewhere, any such polymer may be a single polymer or a set of multiple polymers that differ in at least some aspect, e.g. molecular weight, composition, and so on.) Thus in general, suitable anionic polymers may include e.g. those comprising units of acrylic acid, methacrylic acids, salts of acrylic acid and/or methacrylic acids, and so on. Any such anionic polymer may be a homopolymer, copolymer, and so on. Suitable specific polymers include e.g. polyacrylic acid, sodium polyacrylate, and derivatives, copolymers, and so on, of any such materials.

Other anionic polymers that may be used include e.g. anionic alginates, derivatives thereof, and similar material. Other potentially useful anionic polymers, monomers and/or monomer units are disclosed in U.S. Pat. No. 8,512,863 and in U.S. Patent Application Publication US 2006/0276371, both of which are incorporated by reference herein for the specific purpose of including the anionic materials disclosed therein, into the present document. Any anionic polymer as used herein may comprise monomer units derived from anionic monomers and/or from monomers that, after polymerization, may be rendered anionic. In general, an anionic polymer may comprise anionic moieties in the polymer backbone and/or in side groups or substituents, and may be anionic as made, or may be modified to become anionic while already in a polymeric state.

In some embodiments, an anionic polymer (or, a potentially-anionic polymer) may be structured and arranged so that its ionization state is dependent on a physicochemical condition, e.g. pH. For example, the product available from DOW, Inc. (Midland, MI) under the trade designation ACUSOL 820 is an acrylic polymer (believed to be based on acrylic acid and/or derivatives thereof) that, as supplied, is at a relatively low pH (2.5). Under this condition the polymer is present as a low-viscosity emulsion (30% solids in water). Increasing the pH to a suitably alkaline value (e.g. 8-9) via addition of base will cause the polymer chains to become significantly deprotonated, with the result that their water-solubility increased markedly and the former emulsion becomes a relatively clear solution with a much higher viscosity. It will be appreciated that many polymers of this general type exist, and may be employed for the purposes herein as long as the conditions are established that place the polymers into an anionic state.

Any cationic polymer may be used, with the caveat that the cationic polymer should be sufficiently water soluble, and should possess sufficiently high charge density (under the conditions employed), to allow the objectives presented herein to be achieved. In some embodiments, a cationic polymer for use in the present arrangements will contain cationic nitrogen-containing moieties, e.g. quaternary ammonium or cationic protonated amino moieties. Thus in some embodiments, a cationic polymer that is used to form a coacervate may be, or include, a polyquaternium material, i.e. a polymer that includes quaternary ammonium moieties. Numerous polyquaternium materials are available (e.g. polyquaternium-1 through polyquaternium-47). One particularly useful cationic polymer of this type is polyquaternium-6, also known as polydiallyldimethylammonium chloride or polyDADMAC. Other cationic polymers that may be used include e.g. polyethylenimine, and cationically-modified guar gum.

Other potentially useful cationic polymers, monomers and/or monomer units are disclosed in U.S. Pat. Nos. 85,128,632 and 8,883,700 and in U.S. Patent Application Publication US 2006/0276371, all of which are incorporated by reference herein for the specific purpose of including the cationic materials disclosed therein, into the present document. Any such cationic polymer may comprise monomer units derived from cationic monomers and/or from monomers that, after polymerization, may be rendered cationic. Thus in general, a cationic polymer may comprise cationic moieties in the polymer backbone and/or in side groups or substituents, and may be cationic as made, or may be modified to become cationic while already in a polymeric state. In some embodiments, a cationic polymer (or, a potentially-cationic polymer) may be structured and arranged so that its ionization state is dependent on a physicochemical condition, e.g. in similar manner as discussed above for anionic polymers.

In some embodiments a polyelectrolyte (whether anionic or cationic) may comprise charges that are distributed relatively or substantially uniformly along the polymer. In other embodiments, a polyelectrolyte may exhibit an at least somewhat non-uniform charge distribution, e.g. there may be an at least slightly higher charge density in one or more portions of the polymer chain than in one or more other portions of the polymer chain. Such arrangements are permissible, with the caveat that the polymer chain must exhibit sufficiently high overall charge density that the polymer chain is able to electrostatically interact with an oppositely-charged polymer chain to form a coacervate in the manner discussed herein. Even copolymers, whether e.g. alternating or that are somewhat “blocky” in charge distribution may be used. However any such charged polymeric material, in order to qualify as an anionic or cationic polyelectrolyte for the purposes of forming a coacervate as disclosed herein, must interact electrostatically with oppositely-charged polymers rather than functioning e.g. as a surfactant.

### Second, Hydrophobic Waxing Phase

As mentioned earlier, a waxing/washing concentrate and a washing/waxing composition obtained therefrom by dilution into water, will comprise a second, hydrophobic waxing phase (sometimes referred to herein in paraphrase as a hydrophobic waxing material). In various embodiments, a hydrophobic waxing material may be included in a washing/waxing concentrate in amount of at least 1.0, 2.0, 3.0, 4.0, or 5.0 wt. %. In further embodiments a hydrophobic waxing material may be included in the concentrate at less than 10, 9.0, 8.0, 7.0, or 6.0 wt. %. As discussed in detail below, these ranges will include both any liquid material (e.g. silicone fluid), and any solid or semi-solid material (e.g. silicone resin) that may be e.g. dissolved in the liquid material.

In some embodiments, the hydrophobic film-forming material of the second, hydrophobic waxing phase may form a film purely by “physical” means, e.g. by processes that do not involve the formation of covalent chemical bonds between any constituents of the film-forming material. In some embodiments, the film-forming process may involve at least some formation of chemical bonds between at least some constituents of the film-forming material (for example, the film-forming material may comprise reactive silicone resins that may condense with each other, as discussed in detail later herein). In some embodiments (whether or not the film solidification occurs strictly by physical means or by some combination of physical solidification and formation of chemical bonds) the waxing phase may not comprise any constituents that form chemical bonds to the surface that is being washed/waxed. In other embodiments, the waxing phase may comprise one or more components (e.g. polydimethylsiloxanes that are functionalized to comprise reactive groups such as e.g. amino groups, as discussed in detail later herein) that are configured to react and form bonds with the surface. In some embodiments, any such reactive constituent of the waxing phase may be configured only to react with the surface, and to not react with any other component of the waxing phase. Whatever the type of hydrophobic waxing material that is used (e.g. a true chemical “wax”, or a silicone-based materials, both as discussed below), the hydrophobic waxing material will be uncharged. The arrangements disclosed herein thus differ from arrangements in which charged materials, e.g. particles, are disposed as “cores” within coacervate clusters.

A second, hydrophobic waxing phase 20 comprises at least one hydrophobic, film-forming material. By a film-forming material is meant a material (whether a single material, or a mixture, blend, etc.) that, after being applied to a surface and processed suitably (e.g. dried), forms a stable, protective, hydrophobic film on the surface. (By stable is meant that the film will last on the order of weeks; any such film on e.g. a motor vehicle will be gradually eroded by the elements.) In various embodiments the process of forming such a film may occur solely by physical processes (e.g. by coagulation, solidification, etc., e.g. as liquid constituents are removed) or by a combination of physical processes and chemical processes that involve formation of covalent bonds.

A film-forming material may comprise any single material or combination, blend, mixture, etc. of materials, that is capable of forming a hydrophobic film under deposition conditions of the general type disclosed herein. In some embodiments, such a material may take the form of an actual “wax” as defined in terms of the chemical composition and properties of the material. In this particular instance the term “wax” denotes hydrophobic organic polymeric compounds such as e.g. a long chain aliphatic hydrocarbons, esters and diesters, fatty alcohols, and so on. Such waxes will often exhibit an intermediate molecular weight (e.g. in the range of 300 to 2500 grams per mole, on average) that is higher than that of small molecules (e.g. liquids and gases), but lower than that of polymeric materials such as e.g. polyethylene and the like. Such waxes may be e.g. synthetic, e.g. obtained by oligomerization of a suitable monomer (such as e.g. ethylene) to a suitable intermediate molecular weight. In some embodiments, such waxes may be obtained from plant or animal sources.

Potentially suitable waxes include e.g. paraffin waxes and microcrystalline waxes (derived e.g. from petroleum), montan wax (derived e.g. from coal), animal waxes such as beeswax or shellac wax (obtained from certain insects), and plant waxes such as soy wax, tallow tree wax, castor wax, bayberry wax, and so on. In particular embodiments, such a wax may be carnauba wax, which is obtained from leaves of a particular palm tree and may be particularly suited for use as a film-forming material for the present purposes.

Many such waxes will rely purely on physical methods of film formation. However, in some embodiments a film-forming material may comprise one or more materials of the general type known as drying oils. Such materials may include e.g. linseed oil, urushiol lacquers, and materials of this general type. In some embodiments a film-forming material may take the form of an acrylic resin, e.g. dissolved in a suitable organic solvent. Acrylic resins include various materials such as poly(methylmethacrylate) and related compounds that result from the polymerization of (meth)acrylate monomers. In various embodiments, an acrylic resin may be film-forming purely by physical processes resulting e.g. from removal of solvent; or, such an acrylic resin may comprise reactive groups that allow at least some crosslinking of the polymer chains to occur in the course of film formation. An acrylic resin, if present, can be used in any suitable amount. However, in some embodiments the film-forming material of the waxing composition will comprise less than 5, 3, 1, 0.5, 0.2, 0.1, 0.05, or 0.01 wt. % of any acrylic resin.

### Silicone Materials

In some embodiments a film-forming material may comprise one or more silicone materials. The term silicone material is used in general to refer to a large class of materials that are based on chains and/or networks of Si—O units. In some embodiments, such a silicone material may include, or be, a silicone liquid that is e.g. polydimethylsiloxane (PDMS) or a related material. Such liquids are often comprised of generally linear-chain polymers; the physical properties (e.g. melting point and so on) of such materials may depend on the molecular weight of the polymers.

In some embodiments, such a silicone material may include, or be, a silicone resin. The terminology of a silicone “resin” is used herein to specifically refer to three-dimensional networks comprising Si—O units. In many embodiments such materials may be highly crosslinked to form a cage-like network of SiO₄ units (often referred to as Q units) and to additionally bear, e.g. at outer surfaces of the network, at least some silicon atoms bearing methyl groups. Such methyl-bearing silicon atoms are often referred to as M units in the case of three methyl groups, and as D or T units in the case of two or one methyl groups. Such silicone resins are commonly referred to in the trade as MQ resins (or, as MTQ resins, and so on, depending on the particular structure). Such resins, depending e.g. on their molecular weight, may be e.g. soluble or insoluble in various liquids and at various temperatures. Various such resins may be referred to e.g. as trimethylated silica, trimethyl siloxysilicate, silicic acid (trimethylsilyl ester), silicic acid (diethyoxyoctylsilyl trimethylsilyl ester) and so on. Any such silicone resin, of any suitable structure and composition, may be used. It will be appreciated that any such silicone resin, in order to be able to form a hydrophobic film, should comprise a sufficient number of nonpolar groups (e.g. methyl groups, whether in the form of M, D or T units), e.g. at the outer surfaces of the silicone network, to impart the desired hydrophobicity.

Silicone resins have been found to be particularly advantageous as film-forming materials in the present application. However, some such resins may not be liquid at room temperature. Accordingly, in some embodiments one or more silicone resins may be mixed with one or more silicone liquids (e.g. linear polydimethylsiloxane (PDMS) liquids) to form a film-forming mixture. In some embodiments (depending e.g. on the molecular weight of the silicone resin, its concentration in the silicone liquid, and so on), the silicone resin may become dissolved in the silicone liquid. However, this is not strictly necessary. That is, in some embodiments the silicone resin may merely need to be adequately wetted and suspended in the silicone liquid to an extent that allows the mixture of the two to be used as a film-forming material.

Thus, in some convenient embodiments, a film-forming material of a waxing phase (noting again that the term waxing phase is used herein in accordance with the colloquial use of the term waxing and does not require the presence of a “wax” according to the strict chemical definition of such materials) may comprise a mixture of one or more silicone resins and one or more silicone (e.g. PDMS) liquids. The specific ratio at which the resins and liquids are used may depend e.g. on the molecular weight and structure of the resin, as will be well understood. It will be appreciated that even though some silicone liquids (comprised of e.g. linear PDMS) may not, if used alone, form a satisfactorily hard and durable protective film, such liquids may be advantageous for use in combination with silicone resins with which they can form a durable film. Such silicone liquids are typically non-volatile to the extent that they are expected to remain in the thus-formed protective film, for an extended period (e.g. for as long as the film itself lasts).

Silicone liquids, silicone resins, and blends of silicone liquids and silicone resin which may be suitable for use include for example: products available from Momentive under the trade designations YR 3370 M/T and SS 4230; products available from Dow under the trade designations DOWSIL 2405, DOWSIL MQ-1640, DOWSIL MQ-1600, DOWSIL 2-1912, DOWSIL RSN-0220, DOWSIL RSN-9118, AND DOWSIL 2-2078; products available from Shin-Etsu under the trade designations KR-480, KR-251, and KR-282; products available from Siltech under the trade designations SILIMER Q25 AND SILMER Q30; and, products available from Wacker under the trade designations WACKER TPR, SILRES REN 80, BELSIL B110, AND SILRES 604. (Such products may be referred to by various vendors as, for example, silicone oils, silicone fluids, modified silicone resins, silicone waxes, silicone liquids, silicone mixtures and blends, and so on.) Various silicone materials (e.g. fluids, resins, and blends thereof) are described in detail in U.S. Pat. No. 7,541,323 and in U.S. Patent Application Publication 2005/0250668, both of which are incorporated by reference in their entirety herein. In various embodiments, any such silicone resin and silicone liquid may be combined to form a film-forming material upon which a waxing composition is based. If desired, any film-forming material that comprises a silicone oil and/or a silicone resin, may include additional film-forming ingredients, e.g. any of the waxes described herein.

While neat silicone materials (i.e. mixtures of silicone liquids and silicone resins, at essentially 100% actives) are used in the Representative Example herein, in some embodiments a silicone-based hydrophobic material may be obtained in a form in which it is e.g. pre-dispersed in water. In such a case, the amount of the raw material that is added to arrive at the final, desired level of silicone material in the concentrate can be adjusted in view of the percent actives in the raw material.

The present investigations have revealed that silicone materials (e.g. blends of silicone liquids and silicone resins) are particularly well suited for the purposes of providing excellent hydrophobicity to a “waxed” surface. It is not particularly noteworthy that silicone materials are capable of providing such a property; however, it is quite unexpected that silicone materials are able to be successfully incorporated into a washing/waxing concentrate as disclosed herein. Those of ordinary skill will be aware that silicone oils and resins are often used as antifoaming and defoaming agents. (See e.g. https://www.momentive.com/en-us/categories/antifoams and https://cht-silicones.com/products/antifoams.) The present approach, in which such materials can be included e.g. at a fairly high weight percent into a system that is desired to form a large amount of suds when frothed, thus goes directly against such precepts.

In some embodiments, at least one of the silicone liquids and/or silicone resins that are present may comprise reactive groups that facilitate or assist in film formation. For example, a silicone resin (e.g. an MQ resin) may comprise an effective number of silanol groups that allow the silicone resin to form chemical bonds (such reactions are typically referred to as condensations). However, the present work has indicated that it is not strictly necessary for any such chemical reactions to occur in order to form a satisfactory hydrophobic protective film out of silicone resins and silicone liquids. (It is noted in passing that even a “nonfunctional” silicone resin such as e.g. an MQ resin, may still comprise some silanol groups; however, in a nonfunctional resin the groups are present at such a low concentration that little or no condensation may occur.)

In some embodiments, the waxing phase may comprise one or more constituents that are configured to chemically react with the surface that is to be washed/waxed. Such materials are optional, it having been found in the present work that reactive components are typically not needed when the surface to be washed/waxed is, for example, a clear-coat (e.g. of a vehicle) that is in good condition. However, it has been found that such reactive components can enhance the performance of the waxing composition when the composition is applied e.g. to a clear-coat that is oxidized or otherwise degraded or compromised. That is, in some embodiments such a reactive material may covalently bond to the surface so as to form a compatibilizing layer on the surface to which the film-forming material(s) can more easily adhere.

For example, a reactive silicone fluid may be present in the waxing phase, such as e.g. an amino-functional silicone (e.g. an amino-functional polydimethylsiloxane). Such a reactive silicone fluid may bond to the surface to provide a silicone-rich layer that, for example, a film-forming material comprising e.g. a silicone resin of the general type described above, can readily adhere to. Such a reactive silicone fluid, if present, may only need be present in an amount sufficient to adhere to e.g. areas of the surface that have been degraded. Thus in various embodiments, a reactive ingredient, e.g. a reactive silicone fluid, may be present in the waxing phase at a weight percent of at most 2.0, 1.5, 1.0, 0.8, or 0.6. In further embodiments, such a reactive ingredient may be present at a weight percent of at least 0.1, 0.2, 0.3, 0.4, or 0.5.

Although amino-functional silicones were mentioned above, any suitable functionality may be used, for example acrylo groups, epoxy groups, hydroxyl groups, mercapto groups, silane groups, and so on. Various reactive silicone materials which may be suitable for use include for example: products available from Momentive under the trade designation SEM-253; products available from Dow under the trade designations XIAMETER OFX-0531, XIAMETER OFX-0536, DOWSIL 2-8566, XIAMETER OFX-8468, and XIAMETER OFX-840; and products available from Siltech under the trade designations SILAMINE MUE, SILAMINE C50, and SILAMINE AS. Various reactive silicones and their use are discussed in detail in U.S. Pat. Nos. 6,475,934 and 8,829,092, which are incorporated by reference herein in their entirety for this purpose.

### Surfactant Package

A washing/waxing concentrate, and a washing composition that results from diluting the concentrate into water, will comprise a surfactant package. The term “package” is used broadly; a surfactant package may take the form of one single surfactant (e.g. an anionic surfactant) or may contain multiple surfactants of like or dissimilar types. Thus in various embodiments a surfactant package may comprise multiple anionic surfactants, may comprise one or more anionic surfactants along with one or more zwitterionic surfactants, and so on. The present work has found that, in general, the arrangements disclosed herein seem able to achieve the desired effects when used in combination with various categories of surfactants. Thus, a surfactant package to be used in the arrangements disclosed herein may be chosen from any suitable category of surfactants, e.g. nonionic or ionic (e.g. cationic, anionic, amphoteric, or zwitterionic), or combination thereof.

A primary purpose of such a surfactant package will be to ensure that the washing/waxing concentrate, when diluted to form a washing/waxing composition, is able to perform the desired “washing” function (in addition to the previously-described “waxing” function). Any such surfactant package may thus be chosen to facilitate this. However, any such surfactant package must be configured so that the presence of the surfactant does not prevent the formation and continued existence of coacervates and in particular must not detract from the ability of such coacervates to stabilize droplets of a second, hydrophobic waxing phase. While various surfactant packages have been found acceptable, some particular packages (in terms of surfactant type and/or surfactant amount) have been found to provide enhanced performance.

In some embodiments, a surfactant package may comprise at least one anionic surfactant (e.g., a sulfonate-based anionic surfactant). In various embodiments one or more anionic surfactants may be present in a washing/waxing concentrate at least at 0.4, 0.6, or 0.7 wt. % (in the case of multiple anionic surfactants, this will be the total of all such surfactants); in further embodiments, the one or more anionic surfactants may be present at most at 4.0, 3.0, 2.0, 1.0, or 0.9 wt. %.

As noted, multiple types of surfactant may be present. In some embodiments one or more anionic surfactants may serve as a primary foaming surfactant, with one or more additional non-anionic surfactants serving as a secondary surfactant. In various embodiments one or more secondary surfactants may be present in a washing/waxing concentrate at least at 0.3, 0.4, or 0.5 wt. % (in the case of multiple secondary surfactants, this will be the total of all such surfactants); in further embodiments, the one or more secondary surfactants may be present at most at 1.5, 1.1, 0.90, or 0.70 wt. %. In various embodiments, the one or more secondary surfactants may be e.g. a zwitterionic surfactant, an amphoteric surfactant, or a nonionic surfactant. It has been found that in some instances zwitterionic secondary surfactants seem to enhance the stabilization of foam/suds whose formation is promoted by the one or more anionic surfactants. Thus in some instances the combination of at least one primary surfactant that is an anionic surfactant, and at least one secondary surfactant that is a zwitterionic surfactant, may be particularly beneficial.

Anionic surfactants may, in general, be chosen from e.g. sulfonate-based surfactants (e.g. alpha olefin sulfonates, alkyl benzene sulfonates, sodium dodecylbenzene sulfonates, and so on), sulfate-based surfactants (e.g. sodium lauryl sulfate and sodium lauryl ether sulfate), and so on. Particular anionic surfactants which may be suitable for use include for example: the products available from Stepan under the trade designations WA-EXTRA, STEOL CS-230, STEOL CS-270, BIOTERGE AS-40, MAPROSYL 30B, and BIOTERGE D-40; the products available from Pilot under the trade designations CALFOAM SLS-30, CALFOAM ES-702 and ES-302, CALSOFT AOS-40, CALSOFT LAS-99, the products available from BASF under the trade designations STANDAPOL ES-2 and STANDAPOL ES-3, and the product available from Clariant under the trade designation HOSTAPUR SAS-60. Many potentially useful anionic surfactants are disclosed in U.S. Pat. No. 8,883,700 which is incorporated by reference herein for the specific purpose of including the anionic surfactants disclosed therein, into the present document.

Zwitterionic surfactants may, in general, be chosen (e.g. for inclusion as a secondary surfactant) from e.g. amine oxide-based surfactants (e.g. lauramine oxide-based surfactants, lauryldimethylamine oxide surfactants, myristamine oxide surfactants, etc.), from fatty acid amide and/or betaine type surfactants (e.g. cocamidopropyl betaine, cocamide diethanolamine, and so on), and from similar materials. Particular zwitterionic surfactants that may be useful include for example: the products available form Stepan under the trade designations AMPHOSOL CG and AMMONYX DO, LO, LMDO and MO; the products available from Pilot under the trade designations CALTAINE C-35 and CALAMIDE C; and, the product available from Evonik under the trade designation TEGOTENS DO. Many potentially useful zwitterionic surfactants are disclosed in U.S. Pat. No. 8,883,700 which is incorporated by reference herein for the specific purpose of including the zwitterionic surfactants disclosed therein, into the present document.

Suitable nonionic surfactants may, in general, be chosen (e.g. for inclusion as a secondary surfactant) from e.g. polyoxyethylene sorbitan fatty acid esters, polyoxyethylene sorbitol fatty acid esters and related materials, alkyl polyglucosides and related compounds, polyethylene oxide lauryl ether related materials, and so on. Nonionic surfactants which may be suitable for use include for example: products available from Dow under the trade designations TERGITOL 15-S-9 AND ECOSURF EH-6; the product available from Huntsman under the trade designation SURFONIC L24-7; the product available from Evonik under the trade designation TOMODOL 900; the product available from Croda under the trade designation TWEEN 80; the product available from MilliporeSigma under the trade designation SPAN 80; the product available from BASF under the trade designation LUTENSOL XP60; the product available from BASF under the trade designation GLUCOPON 425N, the product available from Dow under the trade designation CG-425; and, the product available from Stepan under the trade designation BIOSOFT N1. Many potentially useful nonionic surfactants are disclosed in U.S. Pat. No. 8,883,700 which is incorporated by reference herein for the specific purpose of including the nonionic surfactants disclosed therein, into the present document.

Those of ordinary skill will appreciate that the above are only some of the numerous surfactants that are potentially suitable for use. Further descriptions of potentially useful surfactants of various categories (e.g. nonionic, anionic and zwitterionic) can be found e.g. in U.S. Pat. No. 6,506,715, which is incorporated by reference in its entirety herein for this purpose.

While, as noted above, the effects disclosed herein may be achieved by using a waxing composition in combination with any category of surfactant, the present work has found that at least in some instances, enhanced performance may be obtained when using anionic surfactant as primary surfactant and zwitterionic surfactant as a secondary surfactant. In such embodiments, the weight ratio of anionic surfactant to zwitterionic surfactant in the washing/waxing concentrate (and thus in the resulting washing/waxing composition) may be at least 1.05, 1.10, 1.2, 1.3, 1.5, or 2.5. In further embodiments, the weight ratio may be at most 4.0, 3.0, 2.0, 1.6, or 1.4. In various embodiments, the concentrate may comprise from e.g. at least 0.30, 0.40, 0.60, 0.70, 0.80, 0.90, or 1.0 wt. %, to at most 6.0, 5.0, 4.0, 3.0, 2.0, 1.5, 0.75, 0.65, or 0.55 wt. %, of anionic surfactant. In various embodiments, the washing concentrate may comprise from e.g. 0.1, 0.2, 0.3, 0.4, 0.5, 0.7, 0.9, 1.1, or 1.3 wt. %, to at most 3.0, 2.0, 1.5, 1.2, 0.8, or 0.6 wt. % of zwitterionic surfactant.

Although one or more cationic surfactants may be present in some embodiments, it has been found that, as noted above, that anionic surfactants, zwitterionic surfactants, and in particular, combinations thereof, may provide enhanced performance. In various embodiments, a washing concentrate as disclosed herein may comprise less than 2.0, 1.0, 0.5, 0.2, 0.1, 0.05, 0.01, or 0.005 wt. % of (total) cationic surfactant. Correspondingly, a washing composition as achieved by diluting the washing concentrate with water may comprise less than 1.0, 0.5, 0.2, 0.1, 0.05, 0.01, 0.005, 0.001, or 0.0001 wt. % of (total) cationic surfactant.

A washing/waxing concentrate as disclosed herein may comprise a surfactant package that comprises any appropriate total amount of surfactant(s) (e.g., primary anionic surfactant(s) and secondary zwitterionic surfactant(s)). Thus in various embodiments, a washing/waxing concentrate may comprise a surfactant package that makes up at least 0.7, 0.9, 1.1, or 1.3 wt. % of the concentrate. In further embodiments, a concentrate may comprise a surfactant package that makes up at most 6.0, 4.0, 3.0, 2.0, 1.8, 1.6, or 1.5 wt. % of the concentrate.

As noted herein, in some embodiments (e.g. if an anionic polymer is a polyacrylic acid or a polyacrylic acid-derived polymer) it may be necessary to increase the pH of the mixture to ensure that the anionic groups (e.g. COOH/COO⁻/H⁺ moieties) of the polymer are substantially deprotonated, as discussed elsewhere herein. Thus, in some instances a pH-adjusting (e.g. basic) material may be present, in any suitable amount. In some embodiments, such a pH-adjusting material may exhibit buffering capacity e.g. to ensure that any later-added components do not cause the pH to deviate from the desired range. An exemplary, representative pH-adjusting material is triethanolamine, although any suitable material (or combination thereof) may be used. In various embodiments, a pH-adjusting material may be present at least at 0.1, 0.5, 0.8, 1.0, or 1.5 wt. % of the concentrate. In further embodiments, a pH-adjusting material may be present at most at 5.0, 3.0, 2.0, 1.6, 1.0, or 1.2 wt. % of the concentrate.

A washing/waxing concentrate may include any other ingredients for any desired purpose. Such ingredients may include e.g. thickening additives (e.g., carboxymethylcellulose, polyvinylpyrrolidone, xanthan gum, carrageenan, and so on), opacifying additives and/or dyes and colorants, UV-stabilizers, UV-absorbers and the like, fragrances, biocides, preservatives, and so on. Any such ingredient may be present in the washing/waxing concentrate at a level chosen to provide the desired level of the ingredients in the concentrate and/or in the final diluted washing/waxing composition. (Any dye or colorant that may be present will typically be for the purpose of imparting a color to the washing/waxing composition itself and typically will not be visible in the resulting protective film.) In some embodiments, a washing/waxing concentrate may include a desired level (e.g. from 0.5, 1, 2, or 3, up to 10, 8, or 5, wt. %) of salt, e.g. NaCl, as long as such an additive does not interfere with the ability of the coacervate to stabilize the hydrophobic film-forming phase. In some instances such an additive may enhance the hand feel of the washing/waxing composition. Various materials and ingredients that may be suitable for use in a washing/waxing concentrate and composition as disclosed herein are described (although not for the specific purposes and arrangements disclosed herein) e.g. in U.S. Pat. No. 8,883,700, which is incorporated by reference herein in its entirety for this purpose.

The herein-disclosed washing/waxing concentrate is a water-based concentrate, by which is meant that the concentrate comprises at least 75 wt. % water. In various embodiments, the concentrate may comprise at least 80, 84, 88, or 92 wt. % water (in this instance, the term water refers specifically to H₂O).

### Preparation of Washing/Waxing Concentrate

A washing/waxing concentrate as disclosed herein may be prepared in any suitable manner, as long as the procedure is able to generate a coacervate from the polyelectrolytes that are present; and, with the stipulation that the thus-formed coacervate must be able to stabilize droplets of a second, hydrophobic phase. It will be appreciated that formulations that may include various ingredients as disclosed herein, cannot be considered to form a coacervate, and in particular cannot be considered to stabilize a hydrophobic dispersion by way of such a coacervate, unless the conditions under which the ingredients are combined are clearly such that a coacervate is expected to be formed, and are such that it would be expected that droplets of the second, hydrophobic phase would be stabilized by the coacervate.

One general class of exemplary procedures that have been found to work well for such purposes is described as follows. Anionic polymer (which, again, may be a single anionic polymer, or may include multiple anionic polymers) is added to water. If necessary, the conditions are adjusted (e.g. the pH is increased as discussed above) to ensure that the anionic polymer is well-solubilized, and highly ionized, in the water.

With the anionic polymer dissolved in the water (e.g. so that the anionic polymer-water mixture is a clear solution), secondary surfactant (e.g. a zwitterionic surfactant), if used, may be added. Typically, the solution will remain clear. At this point, cationic polymer (which, again, may be a single cationic polymer, or may include multiple cationic polymers) is added to the water, slowly and under high mixing. At this point, the mixture will become turbid, indicating that a coacervate has been formed (and indicating that the presence of the secondary surfactant did not interfere with formation of the coacervate). The viscosity may also drop significantly at this point, indicating that the anionic polymer, which was previously solubilized throughout the aqueous phase in a manner in which it was able to exert a pronounced thickening effect, has had a significant percentage incorporated into coacervate clusters, in which form it is less able to thicken the aqueous phase.

At this point, primary surfactant (e.g. an anionic surfactant) is slowly added to the mixture, with the mixture remaining turbid. Lastly, the desired amount of hydrophobic material that will form the second, hydrophobic waxing phase is added, under high agitation (e.g. by vortexing). In some embodiments, this hydrophobic material will comprise 100% actives (e.g. it may consist of a neat mixture of silicone fluid and resin) with the shearing action of the mixing process acting to break up the hydrophobic material into droplets in the general manner discussed earlier herein. The mixture can be mixed vigorously for an additional amount of time. At this point any ancillary ingredients (e.g. one or more of biocides, colorants, fragrances, and so on) may be added if desired. The result should be a slightly turbid (e.g. milky) concentrate that will be shelf-stable for extended times, e.g. for months or more.

It has been found that procedures along the lines of those presented above can satisfactorily provide a washing/waxing concentrate comprising a coacervate-stabilized hydrophobic second phase, as evidenced by the Working Examples herein. It is noted in particular that even though such a mixture, with surfactant and hydrophobic material present, may be subjected to rather aggressive mixing (e.g. vortexing followed by mixing with a laboratory mixer equipped with e.g. a rotating propeller), this has not been found to cause the hydrophobic material to become emulsified by the surfactant. Rather, the present investigations have indicated that at least a substantial portion of the hydrophobic material ends up as droplets that are stabilized by the coacervate. It is of course possible that some interaction of the surfactant with the coacervate and/or with the hydrophobic material may occur; however, this does not deleteriously affect the coacervate-stabilized hydrophobic phase nor cause the hydrophobic phase to become emulsified by the surfactant.

It is noted that the addition of secondary and primary surfactant in the particular order listed above may not be strictly necessary. However, one observation that has been noted that the addition of anionic primary surfactant to the coacervate system (which, in the Representative Example, already includes zwitterionic secondary surfactant) can frequently have a pronounced thickening effect on the system. While the specific mechanism underlying this is unknown, such an occurrence is advantageous in that it can allow the concentrate to be formulated at a desirably high viscosity as discussed elsewhere herein. In various embodiments, a washing/waxing concentrate as disclosed herein may exhibit a viscosity of from e.g. 800, 1000 or 1200 cP, to e.g. 2000, 1800, or 1600 cP (at room temperature).

### Packaging and Diluting of Concentrate

A washing/waxing concentrate may be provided to an end user in various ways to achieve the ends desired herein. In some instances the concentrate may be provided in bulk in a container, e.g. with instructions as to the nominal dilution ratio to be used. In some instances, a cap of the container may be sized and/or may comprise indicia (e.g. one or more fill-to-here lines) to assist an end user in measuring out the appropriate amount of concentrate. In other embodiments, a washing/waxing concentrate may be provided in one or more premeasured and prepackaged increments (e.g., 15 grams, 30 grams, 60 grams, so as to provide nominal 0.5, 1, and 2 oz quantities) that are appropriate for being added to, e.g., one, two, three, or more gallons of water in a bucket.

A washing/waxing concentrate may be configured to be diluted into water at any desired ratio to form a washing/waxing composition that has active ingredients (e.g. anionic and cationic polymer, surfactant package, and hydrophobic waxing phase) at a wt. % that is suitable to perform the actual concurrent washing and waxing. In various embodiments, a washing/waxing concentrate may be configured to be added to water at a weight ratio of at least 1:250, 1:200, or 1:150 (concentrate:water). In further embodiments, a washing concentrate may be configured to be added to water at a weight ratio of at most 1:10, 1:25, 1:50, 1:75, or 1:100. Alternatively phrased, in various embodiments a washing/waxing concentrate may be configured to be combined with water (e.g. in a bucket) at a ratio of at least 10, 15, 20, 25, 30, 40, 50 or 60 grams of washing/waxing concentrate per gallon of water. In further embodiments, a washing/waxing concentrate may be configured to be combined at a ratio of less than 100, 75, 55, or 35 grams of washing/waxing concentrate per gallon of water. In various embodiments, the ratio of the washing/waxing concentrate to the water in which it is diluted may be at least 0.02, 0.04, 0.08, or 0.16 wt. %; in further embodiments, the ratio of the washing/waxing concentrate to the water may be at most 2.0, 1.5, 1.0, 0.5, or 0.3 wt. %. These and all ranges listed above will include the water present in the concentrate (which may be considerable, e.g. 80 wt. % of more), in such calculations.

Thus as defined herein, a washing/waxing concentrate that is “configured to be diluted into water” to provide a washing/waxing composition with a specified range of various active ingredients, is a concentrate that can be diluted with water to achieve the specified range of active ingredients, without any other compositional alteration or adjustment being needed. In other words, the relative ratios of the active ingredients in the concentrate will be that same as those in the composition, so that addition of water is the sole, and only, action that need be taken to produce the composition from the concentrate.

It is emphasized that a washing/waxing concentrate need not necessarily have the exact same absolute levels of the various ingredients as certain exemplary formulations disclosed herein. The exemplary formulations presented herein are, in the main, configured to be diluted into water at a dilution ratio of 64:1 (water:concentrate). For example, 2 oz of concentrate per gallon of water is a frequently used target. However, a concentrate may be produced with any absolute level of ingredients, e.g. so that the concentrate is configured to be diluted into water at a dilution ratio that is lower than 64:1 (e.g. that is 32:1, 16:1, or 8:1), or at a dilution ratio that is higher than 64:1 (e.g. that is 75:1, 100:1, 125:1, or 150:1). Such concentrates may only differ in terms of the amount of water that is present in the concentrate in comparison to the amount that is to be present in the final washing/waxing composition as used. It is emphasized that such variations in concentrate, e.g. that differ only in the particular amount of dilution that is called for, are encompassed within the disclosures herein. It is further noted that since persons that are e.g. washing a vehicle often do not measure out exact amounts of water and/or concentrate to be mixed together, the washing/waxing concentrates disclosed herein are quite forgiving in the sense that they are expected to still function very well even if the user deviates somewhat, or even fairly substantially, from the nominal (target) dilution ratio.

The ranges of active ingredients in the washing/waxing composition will be commensurate with the degree of dilution into water that is performed. In many embodiments, the levels of active ingredients in the washing/waxing concentrate, in combination with the dilution, will provide that the amounts of active ingredients in the final, diluted washing/waxing composition are extremely small. For example, Tables 1 and 2 in the Representative Working Example reveal that various ingredients are present in the final, diluted washing/waxing composition at extremely low levels (e.g. approximately 0.022 wt. % for the surfactant package, approximately 0.0070 wt. % for the anionic polyelectrolyte, 0.0006 wt. % for the cationic polyelectrolyte, and 0.078 wt. % for the hydrophobic waxing material). In terms of water, washing/waxing composition 1 as obtained by diluting the washing/waxing concentrate into water may comprise a very high percentage of water. In various embodiments, washing/waxing composition 1 may comprise at least 90, 95, 98, 99.0, 99.50, 99.70, or even 99.80 wt. % water (with the term water here referring specifically to H₂O).

It will thus be appreciated that extremely low levels of individual active ingredients, and total active ingredients, may be used. By way of a specific example, the Representative Working Example presented later herein uses a washing/waxing concentrate that is approximately 92 wt. % water, and that when diluted at a nominal 64:1 ratio, provides a washing/waxing composition that is approximately 99.88 wt. % water (in other words, the total percent actives in the washing/waxing composition is approximately 0.12%). It will be appreciated that the ability to perform concurrent washing and waxing with such small amounts of active ingredients is noteworthy.

The following exemplary ranges apply to the final, as-diluted washing/waxing composition as used to wash/wax a surface. In various embodiments a washing/waxing composition as disclosed herein may comprise at least 0.0005, 0.0010, 0.004, or 0.0060 wt. % anionic polymer. In further embodiments, the one or more anionic polymers may be present at most at 0.015, 0.012, 0.009, or 0.008 wt. %. In various embodiments a washing/waxing composition as disclosed herein may comprise at least 0.0003, 0.0004, 0.0005, or 0.0006 wt. % cationic polymer. In further embodiments, the one or more cationic polymers may be present at most at 0.003, 0.0015, 0.0010, or 0.0008 wt. %. In various embodiments a washing/waxing composition as disclosed herein may comprise at least 0.015, 0.030, 0.060, or 0.080 hydrophobic waxing material. In further embodiments the hydrophobic waxing material may be present at most at 0.15, 0.13, 0.11, or 0.09 wt. %.

In various embodiments, a washing/waxing composition may comprise a surfactant package that makes up at least 0.01, 0.013, 0.016, or 0.02 wt. % of the concentrate. In further embodiments, a concentrate may comprise a surfactant package that makes up at most 0.10, 0.08, 0.06, 0.04, or 0.03 wt. % of the concentrate. By way of a specific example, a washing/waxing concentrate that contains 1.4 wt. % of a surfactant package, when diluted in water at 2 oz. concentrate to 1 gallon water (a dilution ratio of 1:64) will result in a washing/waxing composition with the surfactant package present at approximately 0.02 wt. %. In various embodiments, a washing/waxing composition may comprise an anionic surfactant (i.e. as part of a surfactant package) that makes up at least 0.006, 0.008, 0.010, or 0.012 wt. % of the concentrate. In further embodiments, a concentrate may comprise an anionic surfactant that makes up at most 0.06, 0.04, 0.02, or 0.015 wt. % of the concentrate. In various embodiments, a washing/waxing composition may comprise an zwitterionic surfactant (i.e. as part of a surfactant package) that makes up at least 0.005, 0.007, or 0.009 wt. % of the concentrate. In further embodiments, a concentrate may comprise a zwitterionic surfactant that makes up at most 0.02, 0.017, 0.014, or 0.011 wt. % of the concentrate.

An end user of a washing/waxing concentrate may dilute the concentrate into water using any suitable method. In many embodiments, a time-honored method of diluting the concentrate into water using a suitably sized bucket may be used. Typically, a garden hose, e.g. with a spray nozzle, may be used in order to “froth” the mixture during the process of adding water to the final dilution. This will typically provide a well-sudsed washing/waxing composition of the general type shown in FIG. 2.

If desired, a user may pre-rinse an entity (e.g. a motor vehicle) that is to be washed/waxed, e.g. to remove loose dust and debris. Such a pre-rinse is often performed using a garden hose. The user may then immerse a suitable washing implement into the sudsed bucket to allow the washing/waxing composition to imbibe onto and into the implement, after which the implement is put into contact with a desired area of the vehicle. The implement is moved about the area, e.g. with a back-and-forth motion, a swirling motion, or the like, for a desired time. (Typically, a user will make multiple passes over each area.) The implement can be returned to the wash bucket to imbibe more washing/waxing composition, the process repeated for another area to be washed, and so on. This process will provide concurrent washing and waxing as discussed in detail earlier herein.

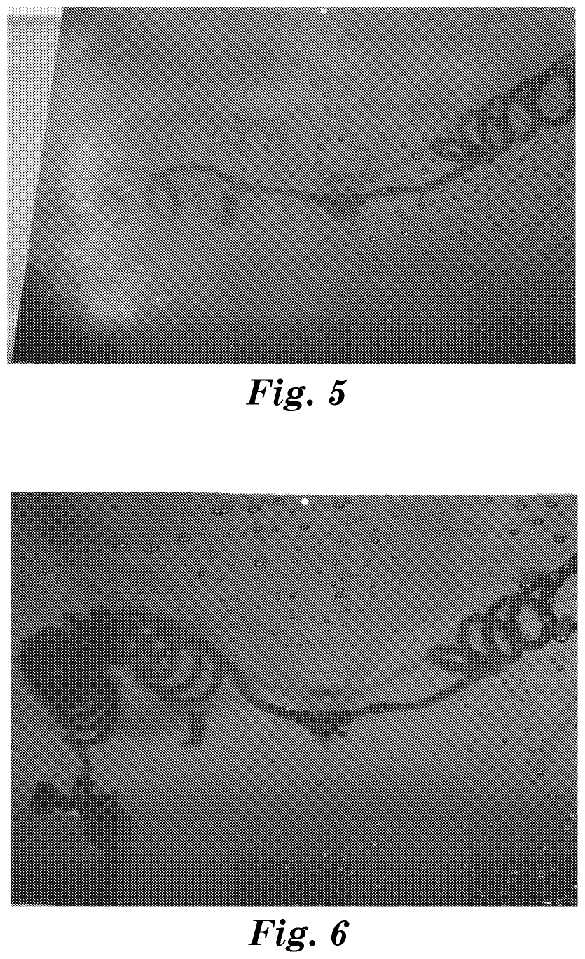

A user may water-rinse each area after it is washed/waxed; or, the user may wait until multiple such areas have been washed/waxed and then rinse them all collectively, as per the user's preference. A surface that has been concurrently washed and waxed as disclosed herein can be rinsed with water immediately after the washing/waxing has been performed. That is, it is not necessary to wait an extended period (e.g. minutes or more) for the hydrophobic protective film to fully form before rinsing the surface. Typically, a hard (e.g. vehicle) surface that has been concurrently washed and waxed as disclosed herein will exhibit a pronounced increase in hydrophobicity (e.g. water will bead up on the surface into fine droplets rather than “sheeting” on the surface) immediately after the rinsing is completed, as evidenced by FIG. 6; in fact, in many instances a surface has been observed to already start to exhibit increased hydrophobicity even during the rinsing process, as evidenced by FIG. 5.

### Washing Implement

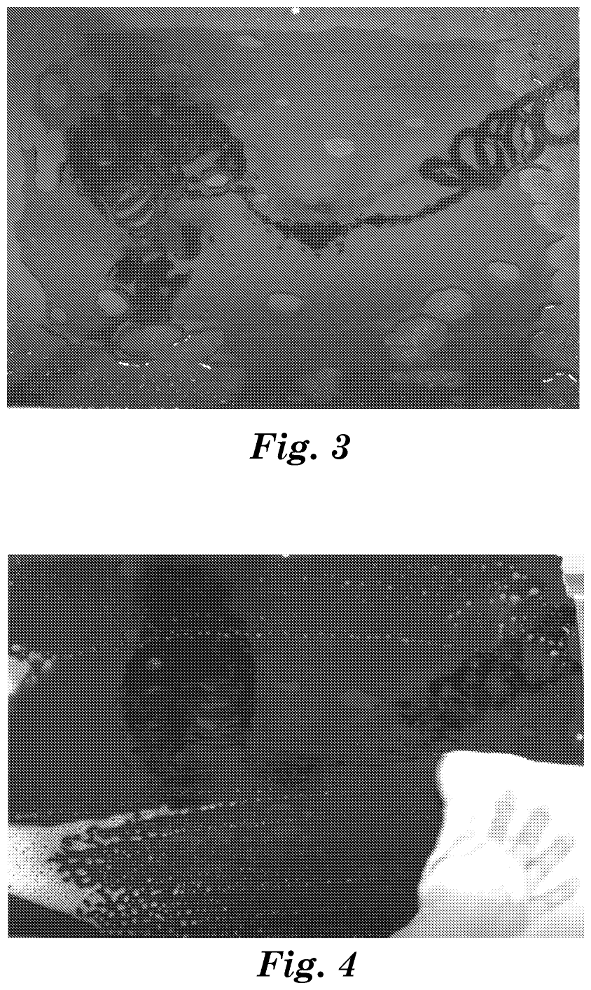

Any suitable washing implement 100 may be used for the purposes herein (noting that in the present arrangement, the implement will serve to perform both washing and waxing, but will be referred to as a washing implement). In various embodiments, such a washing implement may take the form of e.g. a cloth or rag, a sponge, or the like. Any such implement by definition will be used manually. However, the surface-contacting portion of the implement does not necessarily have to be held directly by the user. For example, a washing implement may take the form of a sponge or foam that is connected to a handle that is held by a user (such implements often take the form of a squeegee that comprises a handle with one end comprising an elongated sponge and an oppositely-facing elongated rubber blade). In some embodiments, the washing implement may be held by the user; in other embodiments, the washing implement may take the form of a “mitt” of the general type shown in FIGS. 2 and 4. Such a mitt may have a hollow interior into which the user can insert his or her hand (noting that in FIG. 4, the user is simply holding the mitt rather than inserting their hand thereinto).

The washing implement may be made of any suitable material, processed in any suitable form. In some embodiments, the material may be fibrous, e.g. it may take the form of a woven textile, a non-woven web, and so on. In some embodiments, the material may comprise, or take the form of, microfibers, e.g. having an average diameter of less than 10 microns. The material of the washing implement (e.g., of at least the surface portion of the implement that will contact the surface to be washed and waxed) may be chosen to exhibit any suitable properties. For example, in various embodiments, the washing implement may comprise a material that is hydrophobic, a material that is hydrophilic, or mixtures, blends or combinations thereof. Examples of hydrophobic materials include many microfiber cloths comprised of e.g. polypropylene, polyester, or nylon. Examples of hydrophilic materials include cellulosic cloths and sponges, and the like. In some embodiments the washing implement may be asymmetric. For example, a “mitt” may comprise one major side and/or surface that is relatively hydrophilic (comprising e.g. cellulosic fibers such as e.g. cotton fibers). The mitt may further comprise another, e.g. opposing, major side and/or surface that is relatively hydrophobic in comparison to the hydrophilic side/surface. Such arrangements may, in some instances, enhance the ability to perform concurrent washing and waxing; however, they are not considered to be necessary in order to achieve the objectives disclosed herein.

The compositions and/or methods disclosed herein may be used for the concurrent washing and waxing of any desired hard surface. One common use for such arrangements will be the washing of motor vehicles (e.g. cars, trucks, recreational vehicles, and so on). However, the arrangements herein are not limited to motor vehicles and may encompass e.g. non-motorized campers and so on. Nor is it limited to wheeled vehicles, but rather embraces e.g. motorized boats, sailboats, snowmobiles, aircraft, and so on. In fact, in some embodiments the arrangements disclosed herein may be useful for concurrent washing/waxing of surfaces of immobile or seldom-moved entities and structures, e.g. mobile homes, modular housing, signage, panels or walls of buildings, and so on. In some particular embodiments, the compositions and methods disclosed herein may be used for the concurrent washing/waxing of surfaces that bear an outermost layer of so-called “clearcoat”. Such layers are often found on vehicles, which typically bear a base coat that provides color and optical effects (e.g. a metallic or pearlescent appearance) and a clearcoat that provides physical protection, UV protection, and so on. Many such clearcoats are, for example, acrylic polyurethanes or similar materials. The arrangements disclosed herein are well-suited for concurrent washing/waxing of such surfaces.

### EXAMPLES

The materials listed in Table 1 were obtained:

TABLE 1

| Descriptor | Ingredient | Source |
|---|---|---|
| CALSOFT | Alpha olefin sulfonate surfactant | Pilot Chemical |
| AOS-40 | (40% actives in water) | West Chester, OH |
| AMMONYX | Laurylamine oxide | Stepan Co. |
| LO | zwitterionic surfactant | Northbrook, IL |
| | (30% actives in water) | |
| ACUSOL 820 | Polyacrylate anionic polymer | Dow Chemical |
| | (30% actives in water) | Midland, MI |
| FLOQUAT | PolyDADMAC cationic | SNF Polymer |
| FL4520 | polymer (20% actives in water) | Andrézieux, France |
| DOWSIL | Silicone liquid/resin blend | Dow Chemical |
| 2-1912 | (100% actives) | Midland, MI |
| Triethanolamine | pH adjuster | Thermo Fisher |
| | (100% actives) | Waltham, MA |
| Water | Diluent | House deionized |
| | | water |

### Representative Working Example

The following Working Example is a Representative Example is reported on a basis of 100 grams of concentrate produced. In fact, numerous Working Example batches of various sizes were made and evaluated. To make the 100 gram sample of concentrate, 1.50 grams of ACUSOL A820 (anionic polymer, in the form of a 30% actives/solids emulsion in water, at pH approximately 2.5) was added to 87.3 grams of deionized water under low shear mixing (using a laboratory mixer with a nominal 2 inch diameter propeller, running at approximately 2000 RPM). After the ACUSOL emulsion was thoroughly mixed into the water, 1.00 g of triethanolamine was slowly added to the mixture while stirring. The addition of the triethanolamine caused the pH to increase with the result that the ACUSOL anionic polymer became dissolved in the water (and more fully ionized), such that the water was noticeably more viscous. Stirring was continued for five minutes to ensure complete solubilization of the polymer. After this, 2.0 grams of AMMONYX LO (zwitterionic surfactant, at 30% actives) was added to the mixture.

FLOQUAT FL4520 (cationic polymer, at 20% actives) was diluted into water by a factor of twenty to provide diluted FLOQUAT at 1% actives. 4.0 grams of this diluted FLOQUAT was slowly added to the above mixture under high mixing. (It was found that adding the FLOQUAT slowly, and in diluted form, was helpful in order to prevent the formation of gel clumps.) This resulted in the ACUSOL anionic polymer and the FLOQUAT cationic polymer forming a complex electrostatic coacervate as evidenced by the mixture changing from clear to noticeably turbid. The viscosity of the mixture dropped noticeably as the result of the formation of the coacervate. 2.0 grams of CALSOFT AOS-40 (anionic surfactant, at 40% actives) was slowly added to the mixture. The viscosity of the overall mixture increased noticeably as the result of the addition of the anionic surfactant.

6.0 grams of DOWSIL 2-1912 fluid (silicone liquid/resin blend, 100% actives) was added to the mixture while the mixture was being stirred by a laboratory mixer (nominal 2 inch propeller blade, operating at approximately 2000 RPM). After the DOWSIL had been added, the solution was mixed in this manner for an additional twenty-five minutes. The resulting product (i.e. a washing/waxing concentrate) had a turbid, milky appearance indicating that the silicone fluid had been well-dispersed into the mixture. The pH of the concentrate was in the range of 8.0-8.5, and the viscosity of the concentrate was in the range of 1200-1600 cP. The composition of this washing/waxing concentrate in terms of weight percent active ingredients, and the composition of a washing/waxing composition formed by diluting the concentrate into water at a dilution ratio of 64:1 (water:concentrate) are shown in Table 2. In addition to the weight percentages of the individual components, Table 2 also lists the total weight percent of the non-water (active) ingredients and the weight percent of the surfactant package (the anionic surfactant plus the zwitterionic surfactant).

TABLE 2

| | | Weight | Weight % |
|---|---|---|---|
| | | % in | in diluted |
| Ingredient | Role | concentrate | composition |
| Alpha olefin | Primary (anionic) | 0.80 | 0.0125% |
| sulfonate surfactant | surfactant | | |
| Laurylamine oxide | Secondary (zwitterionic) | 0.60 | 0.0094% |
| surfactant | surfactant | | |
| Polyacrylate | Anionic polymer of | 0.45 | 0.0070% |
| | coacervate | | |
| PolyDADMAC | Cationic polymer of | 0.04 | 0.0006% |
| | coacervate | | |
| Silicone | Hydrophobic, | 1.0 | 0.0156% |
| liquid/resin blend | waxing phase | | |
| Triethanolamine | pH adjuster | 5.0 | 0.078% |
| Water | Diluent | ~92.1% | ~99.88% |
| Total non-water | | 7.89 | 0.12 |
| ingredients | | | |
| Surfactant package | | 1.40 | 0.022 |

### Variations

Numerous variations on the above Representative Working Example were performed, over a variety of ranges of various components (e.g., in terms of active ingredients, from 1.0 to 10 wt. % silicone liquid/resin blend, from 4.-4.0 wt. % primary surfactant, from 0.3-1.5 wt. % secondary surfactant, from 0.03-0.90-wt. % anionic polymer, and from 0.02-0.20 wt. % cationic polymer). By and large, all of these formulations appeared to perform satisfactorily in meeting the objectives outlined in this disclosure; the Representative Working Example is merely singled out as the formulation that is presently preferred in terms of allowing the best balance of performance, cost, and so on.

### Working Example Versus Comparative Example

A Supplemental Working Example formulation was made that was essentially identical to the above-described Representative Working Example formulation except that the DOWSIL 2-1912 silicone fluid was present at 6.0 wt. % rather than at 5.0 wt. % (with the amount of diluent water being adjusted in consequence).

A Comparative Example formulation was made which was essentially identical to the Supplemental Working Example formulation (6.0 wt. % silicone fluid) except that the FLOQUAT cationic polymer was omitted. The Comparative Example thus included anionic polymer, but no cationic polymer, so that a complex electrostatic coacervate could not be formed. The mixture remained clear until the DOWSIL 2-1912 silicone fluid was added, providing an indication that a coacervate indeed had not been formed.

A sample of the Comparative Example was held at 52° C. for one hour, along with a sample of the Supplemental Working Example. At the end of this time, the Comparative Example sample exhibited large-scale macroscopic phase separation, while the Supplemental Working Example sample appeared unchanged (that is, it remained turbid and milky but uniform and homogeneous, without any sign of macroscopic phase separation).

Other samples of the Supplemental Working Example and the Comparative Example were subjected to foaming (by mixing with a propeller-type mixing blade at 600 rpm for ten seconds) and were then observed for five minutes. Based on visual observation, the Supplemental Working Example exhibited much greater foam stability, in terms of both foam density and foam area coverage, in comparison to the Comparative Example. This indicated that the coacervate was able to maintain the silicone fluid in a condition in which the silicone fluid was less able to exert a defoaming effect on the surfactant-promoted foam.

### Accelerated Aging and Shelf Stability

A sample of the above-described Representative Working Example concentrate was subjected to an accelerated aging exposure (45° C. for approximately two months). At the end of this time, the turbid/milky homogenous appearance of the sample was unchanged, indicating that large-scale phase separation had not occurred. This was in contrast to an above-described Comparative Example, which exhibited significant phase separation. In fact, the experiment was continued past the end of the standard two-month accelerated aging protocol. After approximately 8 months at 45° C., the Supplemental Working Example still appeared unchanged, whereas the Comparative Example appeared to be completely macroscopically phase separated.

A sample of the Representative Working Example was also held at 33° F. for two months, to assess any effects of near-freezing conditions. No change in appearance was observed.

### Concurrent Washing and Waxing of Test Panel

A Test Panel (size approximately 24″×18″) was obtained from ACT Test Panels LLC (Hillsdale, MI). The test panel was believed to be made of a similar sheet steel as used in many motor vehicle bodies, and to be coated with a three-layer system comprising a primer layer, a base coat (a color coat, in this case black), and a clear-coat. The three-layer system was believed to be very similar to OEM automotive paints used by one or more major automobile manufacturers in the United States. The Test Panel as used was clean and did not have any pre-existing coating of hydrophobic film-forming material (silicone, wax, or the like) atop the clear-coat.

A concurrent washing/waxing procedure was performed on the Test Panel as described below and was recorded on video. FIGS. 2-6 present screen captures of the video at various times during the procedure (times in 00:00 format below are minutes:seconds).

### Preparation of Washing Waxing Composition

A Supplemental Working Example concentrate was made in similar manner to the above-described Supplemental Working Example concentrate (with 6.0 wt. % DOWSIL 2-1912 silicone fluid). In this case, the concentrate was made in a batch size of approximately 2 Liters. 2 ounces of the concentrate was placed into a plastic bucket (nominal size 3 gallon) and was diluted to 1 gallon (128 ounces) thus the dilution ratio was approximately 64:1. The dilution water was municipal tap water delivered through a hose at the municipal line pressure. A spray nozzle was attached to the end of the hose so that the dilution water was delivered at high velocity to roil and froth the concentrate/water mixture. The thus-formed washing/waxing composition exhibited a large amount of foam atop the liquid surface of the composition, as can be seen in FIG. 2 (noting that FIG. 2 is a screenshot that was taken at the end of the washing/waxing procedure, at the 00:59 mark of the video).

### Pre-Rinsing

The Test Panel was tilted at a slight angle so that the upper edge of the Panel, as seen in FIGS. 3-6, was elevated a few inches in comparison to the lower edge of the Panel, so that excess water would run off, and was pre-rinsed. This was performed by spraying the Panel with water from a hose with a nozzle attached (the reflection of the hose and nozzle are evident e.g. in FIG. 6). The water was municipal tap water at the supplied line pressure; the nozzle was set on a spray setting (a “fan” setting) so as to distribute the water as numerous high-velocity streams. FIG. 3 is a screenshot taken just after the conclusion of this pre-rinsing process (at the 00:06 mark of the video); it is clearly evident from FIG. 3 that the residual water from the pre-rinsing was broadly sheeting on the Test Panel rather than beading up.

### Concurrent Washing/Waxing

The Test Panel was then subjected to a concurrent washing/waxing process. The washing implement that was used was a microfiber wash mitt (visible floating in the bucket in FIG. 2) available from Meguiar's under the trade designation X3002. The wash mitt was immersed in the washing/waxing composition and was then used to wash/wax the Test Panel. The mitt was held in the hand rather than the hand inserted inside the mitt (as evident in FIG. 4, which is a screenshot captured during the washing/waxing process, at the 00:20 mark of the video). The washing/waxing process consisted of several passes back and forth across the Test Panel, after which the washing mitt was flipped to use the other, opposing surface of the washing mitt to perform several passes up and down along the Test Panel. The entire washing/waxing process took less than 15 seconds. As can be seen in FIG. 4, ample foam and suds were present during the washing/waxing.

### Rinsing

Immediately after the completion of the washing/waxing procedure (with a gap of a few seconds to put away the wash mitt and to ready the spray hose and nozzle) the Test Panel was sprayed with the same spray hose/nozzle that had been used to pre-rinse the Test Panel. As in the pre-rinse, for this final rinse the nozzle was set so that the breadth of the spray covered essentially the entire “height” of the Test Panel (as can be seen in FIG. 5, in which the spray is entering from off-camera, on the left). The nozzle was moved back and forth so that the spray was moved back and forth multiple times along the “width” of the Test Panel. The final spray-rinse was performed for approximately 15 seconds, after which no residual foam remained on the Test Panel.

### Water-Beading

As can be seen in FIG. 6, which is a screenshot taken a few seconds after the conclusion of the final spray-rinse (at the 00:53 mark of the video), the residual water from the final rinse was noticeably beaded on the surface of the washed/waxed Test Panel, in sharp contrast to the appearance of the residual water in FIG. 3, after the pre-rinsing and before the washing/waxing. In fact, FIG. 5, which is a screenshot captured toward the end of the final spray-rinsing procedure (at the 00:49 mark of the video), reveals that the water was already beading during the final spray-rinse procedure itself.

FIG. 5 also shows that the spray-rinse (in which the sprayed water streams are entering from the left, as noted above) was quite aggressive. And, even though the spray-rinse was quite forceful (and even though the washing/waxing concentrate and composition included surfactant, as demonstrated by the ample foaming evident in FIGS. 2 and 4), the hydrophobic waxing component (in this case, a film-forming silicone fluid) was able to remain in place on the surface of the Test Panel, in spite of the forceful spray-rinsing in the presence of surfactant.

The entire concurrent washing/waxing process, including the final rinsing but not the pre-rinsing, took just over thirty seconds (the total length of the video, including the pre-rinsing and final rinsing, was 1:03). No buffing or post-treatment was needed in order for the washed/waxed surface to exhibit robust, stable hydrophobicity and water-beading.

The foregoing Examples have been provided for clarity of understanding only, and no unnecessary limitations are to be understood therefrom. The tests and test results described in the Examples are intended to be illustrative rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary embodiments, elements, structures, features, details, arrangements, configurations, etc., that are disclosed herein can be modified and/or combined in numerous ways. It is emphasized that any embodiment disclosed herein may be used in combination with any other embodiment or embodiments disclosed herein, as long as the embodiments are compatible. For example, the methods disclosed herein may be used with a waxing composition, and a washing concentrate, of any of the arrangements, compositional features, and so on, disclosed herein. While a number of exemplary combinations are presented herein, it is emphasized that all such combinations are envisioned and are only prohibited in the specific instance of a combination that is incompatible.

In summary, numerous variations and combinations are contemplated as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms have been discussed herein, in no event should such discussions serve to limit the claimable subject matter. To the extent that there is any conflict or discrepancy between this specification as written and the disclosure in any document that is incorporated by reference herein but to which no priority is claimed, this specification as written will control.

1. A washing/waxing concentrate for dilution into water to form a washing/waxing composition for concurrently washing and waxing a hard surface, the washing/waxing concentrate comprising:
from 1.0 to 10 wt. % of a hydrophobic, film-forming material that is in the form of droplets dispersed in the washing/waxing concentrate;
from 0.03 to 1.0 wt. % anionic polymer and from 0.01 to 0.20 wt. % cationic polymer, the weight ratio of anionic polymer to cationic polymer being at least 1.5:1 and at least some of the cationic polymer and anionic polymer collectively being in the form of a complex electrostatic coacervate that at least partially encapsulates, and stabilizes, the droplets of the hydrophobic, film-forming material;
from 0.50 to 10 wt. % of a surfactant package comprising an anionic surfactant;
and,
at least 75 wt. % water.

2. The washing/waxing concentrate of claim 1 wherein the weight ratio of anionic polymer to cationic polymer is from 5:1 to 15:1.

3. The washing/waxing concentrate of claim 1 wherein the anionic polymer is present at 0.30 to 0.60% wt. %.

4. The washing/waxing concentrate of claim 1 wherein the anionic polymer is chosen from the group consisting of acrylic acid based anionic polymers and alginate-based anionic polymers, and mixtures and combinations thereof.

5. The washing/waxing concentrate of claim 1 wherein the cationic polymer is present at 0.02 to 0.06 wt. %.

6. The washing/waxing concentrate of claim 1 wherein the cationic polymer is chosen from the group consisting of polyquarternium based cationic polymers, ethylenimine based cationic polymers, guar based cationic polymers, and mixtures and combinations thereof.

7. The washing/waxing concentrate of claim 1 wherein the washing/waxing concentrate exhibits a turbid appearance and exhibits a pH of at least 7.5 and a viscosity of at least 1000 cP.

8. The washing/waxing concentrate of claim 1 wherein the at least one anionic surfactant is present in the washing/waxing concentrate at from 0.4 to 4.0 wt. %.

9. The washing/waxing concentrate of claim 8 wherein the at least one anionic surfactant is chosen from the group consisting of sulfonate surfactants, sulfate surfactants, sulfosuccinate surfactants, and mixtures and combinations thereof.

10. The washing/waxing concentrate of claim 1 wherein the surfactant package comprises at least one zwitterionic surfactant that is present in the washing/waxing concentrate at from 0.3 to 1.5 wt. %.

11. The washing/waxing concentrate of claim 10 wherein the at least one zwitterionic surfactant is chosen from the group consisting of amine oxide surfactants, betaine surfactants, and mixtures and combinations thereof.

12. The washing/waxing concentrate of claim 1 wherein the washing/waxing concentrate comprises less than 0.05 wt. % of cationic surfactant.

13. The washing/waxing concentrate of claim 1 wherein the hydrophobic, film-forming material is a silicone-based material comprising at least one silicone liquid comprising a linear, nonreactive polydimethylsiloxane polymer and comprising at least one silicone resin, and wherein the hydrophobic, silicone-based film-forming material is present at from 3 to 7 wt. % of the washing/waxing concentrate.

14. The washing/waxing concentrate of claim 13 wherein the at least one silicone resin comprises a network of Si—O units, at least some of which are SiO₄ (Q) groups, and wherein the at least one silicone resin comprises at least some SiCH₃ (M) groups.

15. A method of concurrently washing and waxing a hard surface, the method comprising:
contacting a washing implement with a washing/waxing composition comprising the washing/waxing concentrate of claim 1 diluted in water at a dilution ratio of from 10:1 to 200:1;
contacting the washing implement bearing the washing/waxing composition with the hard surface and moving the washing implement about the hard surface;
removing the washing implement from the hard surface and rinsing the hard surface with a water rinse,
wherein the moving of the washing implement about the hard surfaces causes suds to be disposed on the hard surface, and wherein upon rinsing the hard surface with the water rinse, the hard surface immediately exhibits increased hydrophobicity.

16. The method of claim 15 wherein the process includes a preliminary step of diluting the washing/waxing concentrate into water in a container to form the washing/waxing composition, the diluting step being performed by directing a high-speed stream or spray of water into the container so that the washing/waxing composition is a sudsed composition bearing visible suds above an upper surface of the washing/waxing composition.

17. The method of claim 15 wherein the surface is a hard surface of a motorized or non-motorized vehicle.

18. A method of making a washing/waxing concentrate, the method comprising:
dissolving anionic polymer in water to a weight ratio of from 0.03 to 1.0 wt. %;
dissolving cationic polymer in the water to a weight ratio of 0.01 to 0.20 wt. % and so that the weight ratio of anionic polymer to cationic polymer is at least 1.5:1;
allowing the anionic polymer and the cationic polymer to form a complex electrostatic coacervate in the water;
adding a surfactant package to the water to a weight ratio of 0.50 to 10 wt. %, the surfactant package comprising an anionic surfactant;
then,
adding a hydrophobic, film-forming material to the water to a weight ratio of 1.0 to 10 wt. % and mixing so that the hydrophobic, film-forming material is in the form of droplets that are dispersed in the washing/waxing concentrate and that are at least partially encapsulated, and stabilized, by the complex electrostatic coacervate.

19. The method of claim 18 wherein the adding of the surfactant package to the water to a weight ratio of 0.50 to 10 wt. % comprises the steps of:
after the anionic polymer is added to the water, but before the cationic polymer is added to the water, adding a zwitterionic surfactant to the water at from 0.3 to 1.5 wt. %;
and,
after the anionic polymer, zwitterionic surfactant, and cationic polymer have been added to the water, but before the hydrophobic, film-forming material is added to the water, adding an anionic surfactant to the water at from 0.4 to 4.0 wt. %.

20. The washing/waxing concentrate of claim 1 wherein the washing/waxing concentrate is configured to be diluted into water to provide a composition that is for concurrently washing and waxing a hard surface and which composition comprises:
from 0.015 to 0.15 wt. % of a hydrophobic, film-forming material that is in the form of droplets dispersed in the washing/waxing composition;
from 0.00050 to 0.015 wt. % anionic polymer and from 0.00030 to 0.0030 wt. % cationic polymer, the weight ratio of anionic polymer to cationic polymer being at least 1.5:1 and at least some of the cationic polymer and anionic polymer collectively being in the form of a complex electrostatic coacervate that at least partially encapsulates, and stabilizes, the droplets of the hydrophobic, film-forming material;
from 0.011 to 0.10 wt. % of a surfactant package comprising an anionic surfactant;
and,
at least 99.5 wt. % water.
